(19) United States
(12) Patent Application Publication
(10) Pub. No.: US 2009/0156763 A1
(43) Pub. Date: Jun. 18, 2009

(54) Process for manufacturing a thermoplastic elastomeric material

(76) Inventors: Roberta Sulcis, Volterra (Pisa) (IT); Elisa Passaglia, Pisa (IT); Francesco Ciardelli, Pisa (IT); Emiliano Resmini, Milano (IT); Diego Tirelli, Milano (IT); Claudio Bianchini, Firenze (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/990,989

(22) PCT Filed: Aug. 30, 2005
(86) PCT No.: PCT/EP2005/009329

§ 371 Date: Feb. 26, 2008

(51) Int. Cl. C08F 4/42; C08F 4/52

(52) U.S. Cl. 526/160; 526/159; 526/171

(57) ABSTRACT

A process for manufacturing a thermoplastic elastomeric material includes at least one elastomeric phase and at least one thermoplastic phase by the following steps: surface-treating a vulcanized rubber in a subdivided form with an effective amount of at least one organometallic polymerization catalyst; and polymerizing at least one ethylenically unsaturated monomer in the presence of the surface-treated vulcanized rubber in a subdivided form to obtain at least one thermoplastic phase.

The present invention relates to a process for manufacturing a thermoplastic elastomeric material.

In particular, the present invention relates to a process for manufacturing a thermoplastic elastomeric material, said process comprising a catalytic polymerization of at least one ethylenically unsaturated monomer in the presence of a vulcanized rubber in a subdivided form.

In a further aspect, the present invention also relates to a manufactured product including said thermoplastic elastomeric material.

The increased production of industrial rubber products has resulted in the accumulation of large amounts of rubber wastes which are generally disposed in dedicated landfills with the main drawbacks of environment pollution as well as of the need for large dedicated areas for storing said wastes.

It is known in the art to depolymerize waste rubber, such as tires, in an effort to reduce the volume of waste and obtain a useful byproduct. Likewise, rubber products may be devulcanized in an attempt to recycle the waste rubber.

In addition to these techniques, it is common in the art to grind the waste rubber and utilize the ground particles so obtained. These ground particles may then be compounded with thermoplastic polymeric materials in order to make final products which may be employed in a plurality of applications. Said ground particles may be added to substantially thermoplastic polymers such as, for example, polyethylene, polypropylene, polystyrene, polyesters, polyamides, to improve both their toughness and their impact strength.

However, it has been found that the mere addition of such ground rubber particles to said thermoplastic polymeric materials often results in a significant deterioration of the mechanical properties of the resulting products mainly due to a scarce compatibility between the ground rubber particles and the thermoplastic polymers.

Many efforts have been made in the art in order to overcome the above disclosed problems.

For example, the article of D. Tuchman and S. L. Rosen published in “Journal of Elastomers and Plastics”, Vol. 10, pp. 115-128 (1978), discloses the addition of cryogenically ground tire rubber to various thermoplastic polymers including polypropylene, polyethylene and polystyrene. In particular, with regard to polystyrene, the authors believed that the cryogenically ground tire rubber acts as a moderately good impact enhancer when mechanically blended with polystyrene. A mechanical blend comprising 20% by weight of cryogenically ground tire rubber produces a material mechanically comparable to a medium impact polystyrene. Moreover, the authors investigated several techniques in order to graft styrene to the cryogenically ground tyre rubber. To this aim, different techniques were investigated such as, for example, free radical grafting in bulk and ionic grafting promoted by mineral acid. According to the authors, only an aqueous slurry process using a water-soluble initiator system was successful in giving a product having improved impact strength with respect to a product obtained by a straight mechanical blend. At the same time, tensile strength and modulus of the obtained product were maintained at fairly high levels.

U.S. Pat. No. 3,042,634 discloses a process of making a rubber-resin product which comprises heating a mixture comprising comminuted vulcanized rubber, water and a resin-forming monomeric material particularly monoolefins such as, for example, styrene, α-methyl styrene, and acrylonitrile, and mixtures thereof, at a temperature of from 125° C. to 250° C.; and recovering a dry-rubber resin product therefrom that may be masticated to give a uniform smooth rubber-resin blend. Peroxide catalysts, such as potassium persulfate, benzoyl peroxide, cumene hydroperoxide may be included. The abovementioned rubber-resin product is said to range from a stiffened rubbery product at the lower styrene monomer charge to a rigid brittle gum plastic at high styrene monomer charge. No mention is made about the mechanical properties of the obtained rubber-resin product.

Patent application GB 2,022,105 discloses a method of making plastic materials incorporating reclaimed tire rubber which comprises: swelling said reclaimed tire rubber with a quantity of monomer which is insufficient to saturate said reclaimed tire rubber; and polymerizing the swollen mass. The polymerization can be initiated thermally or, conveniently, by a free radical initiator such as benzoyl peroxide which can conveniently be pre-mixed with the monomer. Monomers which may be conveniently used are selected from: vinyl aromatic compounds such as, for example, styrene, or substituted styrenes (for example, β-bromostyrene, chlorostyrene); acrylonitrile; divinyl benzene; or mixtures thereof. The obtained plastic materials are said to have good impact strength, tensile strength and elongation at break.

The article of M. Pittolo and R. P. Burford published in “Journal of Material Science”, Vol. 21, pp. 1769-1774 (1986), discloses a study on rubber-crumb modified polystyrene. In particular, peroxide crosslinked polybutadiene and styrene/butadiene rubber powders were converted to semi-interpenetrating networks by swelling in styrene monomer and subsequent homopolymerization. Two radical initiator types were selected, one causing bonding between polystyrene and the rubber (benzoyl peroxide), the other allowing independent polymerization [azobis(isobutyro-nitrile)]. The polystyrene modified powders were then incorporated into a polystyrene matrix and the tensile properties of the resulting composites were determined. Improvements in performance over untreated crumb-modified composites were observed, with increased breaking strains due to crazing.

The article of M. Pittolo and R. P. Burford published in “Rubber Chemistry and Technology”, Vol. 58, pp. 97-106 (1986), discloses the use of recycled rubber-crumb as thoughener of polystyrene. In particular, the rubber-crumb were treated with styrene monomer and benzoyl peroxide in order to graft the polystyrene on the rubber-crumb surface. The obtained modified rubber-crumb was then incorporated into a polystyrene matrix obtaining a composite material. The toughness of the obtained composite material is said to increase with increasing rubber-to-matrix adhesion and decreasing particle size of the rubber-crumb. Moreover, the breaking strain and the energy at break are said to increase with the increase of the grafting degree as, on the contrary, the tensile strength is said to decrease.

However, the use of said radical initiators may show some drawbacks. Firstly, the use of said radical initiators may cause handling and storage problems due to the instability of said products. Moreover, the obtained products not always show good properties (in particular, in term of impact strength and mechanical properties) mainly due to a lower degree of grafting of the monomers onto the surface of the vulcanized ground rubber.

The Applicant has faced the problem of improving the impact strength of thermoplastic elastomeric materials incorporating vulcanized ground rubber. In particular, the Applicant has faced the problem of improving the impact strength of thermoplastic elastomeric materials comprising a vulcanized ground rubber and at least one thermoplastic polymer, while maintaining satisfactory mechanical properties.

The Applicant has now found that it is possible to improve said impact strength, while maintaining satisfactory mechanical properties, by means of a process comprising a catalytic polymerization of at least one ethylenically unsaturated monomer in the presence of a vulcanized ground rubber, said vulcanized ground rubber being surface-treated with at least one organometallic polymerization catalyst. Said process yields thermoplastic elastomeric materials showing an improved impact strength which may be directly used in order to make manufactured products. Moreover, said thermoplastic elastomeric materials may be used as blends with other polymeric materials, in particular with polymeric materials having similar monomeric composition, in order to improve their impact strength.

Furthermore, said process allows to obtain thermoplastic elastomeric materials showing satisfactory mechanical properties, in particular tensile strength at yield, elongation at yield, stress at break, elongation at break, and tangent modulus.

According to a first aspect, the present invention relates to a process for manufacturing a thermoplastic elastomeric material comprising at least one elastomeric phase and at least one thermoplastic phase, said process comprising the following steps:
surface-treating a vulcanized rubber in a subdivided form with an effective amount of at least one organometallic polymerization catalyst;
polymerizing at least one ethylenically unsaturated monomer in the presence of said surface-treated vulcanized rubber in a subdivided form to obtain at least one thermoplastic phase.

For the purposes of the present description and of the claims which follow, in the expression “organometallic polymerization catalyst”, the term “organometallic” is referred to the active species of said polymerization catalyst.

According to one preferred embodiment, said organometallic polymerization catalyst may be selected from:
Ziegler-Natta catalysts;
metallocene catalysts.

According to a further embodiment, said process may be carried out in the presence of carbon monoxide.

In the case said thermoplastic elastomeric material is a copolymer of at least one ethylenically unsaturated monomer and carbon monoxide, said organometallic polymerization catalyst may be selected from polymerization catalysts comprising:
(a) a metal compound, said metal belonging to group VIIIA of the Periodic Table of the Elements;
(b) an anion of an acid with a pKa of less than 2 or a metal salt thereof;
(c) a bidentate ligand.

For the sake of brevity, the above disclosed polymerization catalysts comprising from (a) to (c) components will be hereinafter referred to as “organometallic polymerization catalysts containing ligands”.

It should be pointed out that, for the purposes of the present description and the claims which follow, the references to the Periodic Table of the Elements refer to the version of the table published in the “Handbook of Chemistry and Physics”, published by the CRC, 1989-1990, using the IUPAC system as regards the groups.

According to one preferred embodiment, said organometallic polymerization catalyst may be used in an amount of from 0.01% by weight to 5% by weight, preferably of from 0.05% by weight to 1% by weight, with respect to the total weight of the vulcanized rubber in a subdivided form.

According to one preferred embodiment, said polymerizing step may be carried out at a temperature of from 20° C. to 100° C., more preferably of from 30° C. to 90° C., at a pressure of from 1 bar to 60 bar, preferably of from 2 bar to 45 bar, for a time of from 5 minutes to 10 hours, more preferably of from 10 minutes to 3 hours.

According to a further preferred embodiment, said polymerizing step may be carried out in the presence of water.

According to a further preferred embodiment, said polymerizing step may be carried out in the presence of at least one inert solvent.

According to one preferred embodiment, said thermoplastic elastomeric material comprises:
from 10% by weight to 99% by weight, preferably from 20% by weight to 95% by weight, with respect to the total weight of the thermoplastic elastomeric material, of at least one thermoplastic polymer;
from 1% by weight to 90% by weight, preferably from 5% by weight to 80% by weight, with respect to the total weight of the thermoplastic elastomeric material, of a vulcanized rubber in a subdivided form.

For the purposes of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

The vulcanized rubber in a subdivided form which is used in the present invention may be obtained by grinding or otherwise comminuting any source of vulcanized rubber compound such as, for example, tires, roofing membranes, hoses, gaskets, and the like, and is preferably obtained from reclaimed or scrap tires using any conventional method. For example, the vulcanized rubber in a subdivided form may be obtained by mechanical grinding at ambient temperature or in the presence of a cryogenic coolant (i.e. liquid nitrogen). Any steel or other metallic inclusions should be removed from the ground tires before use. Usually, fibrous material such as, for example, tire cord fibers, is preferably removed from the ground rubber using conventional separation methods.

According to one preferred embodiment, the vulcanized rubber in a subdivided form which may be used in the present invention, is in the form of powder or granules having a particle size not higher than 10 mm, preferably not higher than 5 mm.

According to a more preferred embodiment, the vulcanized rubber in a subdivided form which may be used in the present invention, has a particle size not higher than 0.5 mm, preferably not higher than 0.2 mm, more preferably not higher than 0.1 mm.

According to one preferred embodiment, the vulcanized rubber in a subdivided form may comprise at least one crosslinked diene elastomeric polymer or copolymer which may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the crosslinked diene elastomeric polymer or copolymer may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

Alternatively, the vulcanized rubber in a subdivided form may further comprise at least one crosslinked elastomeric polymer of one or more monoolefins with an olefinic comonomer or derivatives thereof. The monoolefins may be selected, for example, from: ethylene and α-olefins generally containing from 3 to 12 carbon atoms such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

According to one preferred embodiment, the Ziegler-Natta catalysts may be selected from those obtained by mixing an organometallic compound of a metal belonging to the Group IA, IIA, or IIIB of the Periodic Table of the Elements with a compound of a transition metal belonging to the Group IVA, VA, VIA, or VIIIA of the Periodic Table of the Elements.

Usually, the organometallic compounds of a metal belonging to the Group IA, IIA, or IIIB of the Periodic Table of the Elements includes the hydrides, aluminum alkyls, aluminum haloalkyl, alkylaluminum halides, Grignard reagents, alkali metal aluminium hydrides, alkaly metal borohydrides, alkaly metal hydrides, alkaline earth metal hydrides, or mixtures thereof.

Preferably, aluminum trialkyl compounds may be advantageously used for obtaining the catalysts according to the present invention. Said aluminum trialkyl compounds may be selected from any conventional or known aluminum trialkyl compounds such as, for example, aluminum trimethyl, aluminum triethyl, aluminum tripropyl, aluminum triisobutyl; or higher aluminium trialkyl compounds having, for example, an average composition of aluminum trioctyl or tridodecyl without limitation of the number of carbon atoms; or mixtures thereof. Aluminum trimethyl, aluminum triethyl, or mixture thereof, are particularly preferred.

The compound of a transition metal belonging to the Group IVA, VA, VIA, or VIIIA of the Periodic Table of the Elements which may be advantageously used for obtaining the catalysts according to the present invention, may be selected, for example, from: halogenides such as chlorides, bromides, or fluorides; oxides or hydroxides; or organic compounds such as, alcoholates, acetates, benzoates, acetyl acetonates; or mixtures thereof. Chlorides are particularly preferred.

Preferably, the transition metal may be selected, for example from: titanium, zirconium, hafnium, vanadium, niobium, tantalum, chromium, molybdenum, tungsten, or mixtures thereof. Titanium is particularly preferred.

Preferably, the catalyst particularly useful according to the present invention, may be obtained by mixing aluminum trimethyl or aluminum triethyl with titanium tetrachloride.

More details about the Ziegler-Natta catalysts above disclosed may be found, for example, in U.S. Pat. No. 3,113,115, U.S. Pat. No. 3,257,332 or U.S. Pat. No. 3,505,301.

According to one preferred embodiment, the metallocene catalysts may be selected, for example, from compounds having the following general formulae (III) or (IV):

(C₅R′ₘ)ₚR″ₛ(C₅R′ₘ)M(Q)₃₋ₚ (III)

R″ₛ(C₅R′ₘ)M(Q′) (IV)

wherein:
C₅R′ₘ represents an unsubstituted or substituted and/or fused cyclopentadienyl group;
R′ groups, which may be equal or different from each other, represent a hydrocarbyl group such as, for example, alkyl, alkenyl, aryl, alkylaryl, or arylalkyl groups containg from 1 to 20 carbon atoms, or two adjacent carbon atoms which are joined together to form a C₄-C₆ ring;
R″ represents a C₁-C₄ alkylene group, a dialkyl germanium or silicone, or an alkyl phosphine or amine group bridging two C₅R′ₘ rings;
M represents a transition metal belonging to the groups IVA, VA, VIA, or VIIIA of the Periodic Table of Elements;
Q groups, which may be equal or different from each other, represent a hydrocarbyl group such as, for example, alkyl, alkoxy, alkenyl, aryl, alkylaryl, or arylalkyl groups, containing from 1 to 20 carbon atoms, or halogens atoms;
Q′ represents an alkylidene group having from 1 to 20 carbon atoms;
p is 0, 1, or 2;
s is 0 or 1;
n and z are 0, or an integer of from 1 to 3, extremes included.

Preferably, when S is 0 p is 0; when s is 1, m is 4, when s is 0, m is 5.

When R″ represents an alkyl phosphine group, said alkyl phosphine group may be hydrosoluble or not.

Specific examples of hydrocarbyl groups are: methyl, ethyl, propyl, butyl, amyl, isoamyl, isobutyl, heptyl, octyl, nonyl, decyl, cetyl, 2-ethylhexyl, methoxy, ethoxy, butoxy, phenyl.

Specific examples of alkylene groups are: methylene, ethylene, propylene.

Specific examples of halogen atoms are: chlorine, bromine, iodine, preferably chlorine.

Specific examples of alkylidene groups are: methylidene, ethylidene, propylidene.

Preferably, M represents titanium, zirconium, vanadium, hafnium, more preferably zirconium or titanium.

Specific example of compounds having general formulae (III) or (IV) which may be advantageously used according to the present invention are: cyclopentadienyl titanium or zirconium trichloride, pentamethylcyclopentadienyl titanium or zirconium trichloride, pentamethylcyclopentadienyl titanium or zirconium trimethoxide, bis-(cyclopentadienyl)titanium or zirconium diphenyl, bis(cyclopentadienyl)titanium or zirconium dimethyl, bis(cyclopentadienyl)titanium or zirconium methyl chloride, bis(cyclopentadienyl) titanium or zirconium ethylchloride, bis(cyclopentadienyl)titanium or zirconium dichloride, bis(n-butylcyclopentadienyl) titanium or zirconium dichloride, bis(n-dodecylcylopenta-dienyl)titanium or zirconium dichloride, ethylene-bis(tetrahydroindenyl) titanium or zirconium dichloride, ethylene-bis(tetrahydroindenyl)titanium or zirconium dimethyl, ethylene-bis-(indenyl)titanium or zirconium dichloride, ethylene-bis(indenyl)titanium or zirconium dimethyl, dimethylsilanylene-bis-(tetrahydroindenyl)-titanium or zirconium dichloride, dimethyl-silanylene-bis(tetrahydroindenyl)titanium or zirconium dimethyl, dimethylsilanylene-bis(indenyl)titanium or zirconium dichloride, dimethylsilanylene-bis(indenyl) titanium or zirconium dimethyl. Pentamethyl cyclopentadienyl titanium trichloride, pentamethylcyclopentadienyl titanium trimethoxide, or bis(cyclopentadienyl)zirconium dichloride, are preferred.

Said compounds having general formulae (III) or (IV) are usually used in combination with a co-catalyst, preferably an aluminoxane, which are well known in the art and which may be represented by the following general formulae (V) or (VI):

(R—Al—O) (V)

which is a cyclic compound,

R(R—Al—O)ₙAlR₂ (VI)

which is a linear compound,
wherein:
R groups, which may be equal or different from each other, represent a linear or branched C₁-C₅ alkyl group such as, for example, methyl, ethyl, propyl, butyl, pentyl, preferably methyl;
n is an integer of from 1 to 20, extremes included. Methylalumoxane (MAO) is particularly preferred.

Alternatively, an organoboron compound may be used as a co-catalyst. Specific examples of organoboron compounds which may be advantageously used according to the present invention are: trifluoroborane, tris(4-fluorophenyl)borane, tris(3,5-difluorophenyl)borane, tris(4-fluoromethylphenyl)-borane, tris(3,4,5-trifluorophenyl)borane, tris(penta-fluorophenyl)borane, tris(tolyl)borane, tris(3,5-dimethyl-phenyl)borane, or mixtures thereof.

More details about the metallocene catalysts above disclosed may be found, for example, in U.S. Pat. No. 4,530,914 or U.S. Pat. No. 6,908,876.

According to one preferred embodiment, the organometallic polymerization catalysts containing ligands may comprise:
(a) a metal compound such as a palladium compound, a cobalt compound, a iron compound, or a nickel compound, preferably a palladium compound;
(b) an anion of an acid with a pKa of less than 2 or a metal salt thereof;
(c) a bidentate ligand having the following general formula (VII):

R¹R²-M¹-R³-M¹-R⁴R⁵ (VII)

wherein:
R¹, R², R¹, R⁴ and R⁵, which may be equal or different from each other, represent a hydrocarbon group containing from 2 to 18, preferably from 6 to 14, carbon atoms, preferably an aryl group, more preferably a phenyl group;
M¹ represents phosphorous, arsenicum or antimony, preferably phosphorous;
R³ represents a bivalent organic bridging group having at least two carbon atoms in the bridge, such as, for example: a —(CR⁶R⁷)ₙ— group wherein R⁶ and R⁷ represent a hydrogen atom or a hydrocarbon group offering no steric hindrance, preferably a hydrogen atom, and n is an integer of from 2 to 4, extremes included; an aryl group such as phenyl, benzene, naphthalene; a cycloaliphatic group such as, cyclohexane group; a —(CR⁶R⁷)ₙ— group is preferred.

Preferably, the metal compound (a) is selected from palladium salts of a carboxylic acid such as, for example, palladium acetate, palladium trifluoroacetate, palladium tosilate; or from palladium salts such as, for example, [PdCl (Me) (cod)] (cod=cycloocta-1,5-diene), or mixtures thereof.

Preferably, the anion of an acid with a pKa of less than 2 or a metal salt thereof (b) is selected from anions derived from the following acids or metal salts thereof:
mineral protonic acids which may be selected, for example, from: sulphuric acid, nitric acid, boric acid, tetrafluoroboric acid, perchloric acid, sulphonic acid (such as methane sulphonic acid, trifluoromethanesulphonic acid, p-toluene sulphonic acid), thrichloroacetic acid, trifluoroacetic acid, or mixtures thereof;
Lewis acids which may be selected, for example, from: boron compounds such as, for example, triphenylborane, tris(pentafluorophenyl)borane, (p-chlorophenyl)borane, tris[3,5-bis(trifluoromethyl)phenyl]borane; or from compounds of aluminum, of zinc, of antimony, or of titanium which have Lewis-acid character; or mixtures thereof;
   or mixtures thereof.

Preferably, the bidentate ligand (c) is selected from: 1,3-di(diphenylphosphine)propane, 1,4-di(diphenyl-phosphine)butane, 2,3-dimethyl-1,4-di(diphenylphosphine)-butane, 1,4-di(dicyclohexylphosphine)butane, 1,5-di(di-naphthylphosphine)pentane, 1,2-di(diphenylphosphine)-benzene, 1,2-di(diphenylphosphine)cyclohexane, or mixtures thereof. 1,3-Di(diphenylphosphine)propane is particularly preferred. Said phosphines may be hydrosoluble or not.

Preferably, the metal catalysts containing ligands above disclosed, further comprise at least one compound (d) selected from 1,4-quinones such as, for example, 1,4-benzoquinone, 1,4-naphthoquinone, or mixture thereof.

More details about the organometallic polymerization catalysts containing ligands above disclosed may be found, for example, in U.S. Pat. No. 4,970,294 or U.S. Pat. No. 6,670,443, or in European Patent Application EP 121,965.

According to one preferred embodiment, the vulcanized rubber in a subdivided form may be subjected, before being subjected to a surface, treating step above disclosed, to a solvent extraction, for example, with boiling toluene, for removing low molecular weight ingredients usually present such as, for example plasticizers, accelerators, crosslinking agents, or other additives usually present.

The above disclosed step of surface treating a vulcanized rubber in a subdivided form may be carried out as follows.

The vulcanized rubber in a subdivided form may be surface-treated with the various component of the organometallic polymerization catalysts in any order.

For example, in the case of Ziegler-Natta catalysts, said surface treating step comprises the following steps:
(i) reacting said vulcanized rubber in a subdivided form, previously swolled in an inert solvent such as, for example, toluene, methanol, or mixtures thereof, with at least one organometallic compound of a metal belonging to the Group IA, IIA, or IIIB of the Periodic Table of the Elements, at a temperature of from 30° C. to 8° C., preferably of from 50° C. to 70° C., for a time of from 30 minutes to 2 hours, preferably of from 40 minutes to 1.5 hour, said organometallic compound being used in an amount of from 10% by to 150% by weight, preferably of from 30% by weight to 100% by weight, with respect to the total weight of the vulcanized rubber in a subdivided form;
(ii) reacting the compound obtained in step (i) with a compound of a transition metal belonging to the Group IVA, VA, VIA, or VIIIA of the Periodic Table of the Elements, at a temperature of from 40° C. to 100° C., preferably of from GOC to 90° C., for a time of from 30 minutes to 4 hours, preferably of from 1 hour to 3 hours, said compound of a transition metal belonging to the Group IVA, VA, VIA, or VIIIA of the Periodic Table of the Elements being used in an amount of from 1% by to 10% by weight, preferably of from 2% by weight to 6% by weight, with respect to the total weight of the vulcanized rubber in a subdivided form.

Preferably, in the case of metallocene catalysts, said surface treating step comprises the following steps:
(i′) reacting said vulcanized rubber in a subdivided form, previously swolled in an inert solvent, such as, for example, toluene, methanol, or mixtures thereof, with at least one aluminoxane having general formulae (V) or (VI), in the presence of an inert solvent, preferably toluene, at a temperature of from 30° C. to 80° C., preferably of from 50° C. to 70° C., for a time of from 30 minutes to 2 hours, preferably of from 40 minutes to 1.5 hours, said aluminoxane being used in an amount of from 10% by to 1500% by weight, preferably of from 50% by weight to 1000% by weight, with respect to the total weight of the vulcanized rubber in a subdivided form;
(ii′) reacting the compound obtained in step (i′) with at least one compound having general formulae (III) or (IV), at a temperature of from 40° C. to 100° C., preferably of from 60° C. to 90° C., for a time of from 30 minutes to 4 hours, more preferably of from 1 hours to 3 hours, said compound having general formulae (III) or (IV) being used in an amount of from 0.01% by to 5% by weight, preferably of from 0.05% by weight to 1% by weight, with respect to the total weight of the vulcanized rubber in a subdivided form.

Preferably, in the case of the organometallic catalysts containing ligands, said surface treating comprises the reaction of said vulcanized rubber in a subdivided form, previously swolled in an inert solvent, such as, for example, toluene, methanol, or mixtures thereof, with at least one organometallic polymerization catalysts containing ligands comprising from (a) to (c) components above disclosed, at a temperature of from 10° C. to 50° C., preferably of from 20° C. to 30° C., for a time of from 60 minutes to 2 hours, preferably of from 40 minutes to 1.5 hour, said catalyst being used in an amount of from 0.01% by to 1% by weight, preferably of from 0.3% by weight to 0.6% by weight, with respect to the total weight of the vulcanized rubber in a subdivided form.

According to one preferred embodiment, said at least one ethylenically unsaturated monomer may be selected, for example, from aliphatic or aromatic ethylenically unsaturated monomers.

With regard to the aliphatic ethylenically unsaturated monomer, the term “aliphatic ethylenically unsaturated monomer” generally means an ethylenically unsaturated monomer having general formula (I):

CH₂═CH—R (I)

wherein R represents a hydrogen atom; a linear or branched alkyl group containing from 1 to 12 carbon atoms; —(R′)ₙ—COO—R″ wherein R′ represents a linear or branched alkylene group containing from 1 to 20 carbon atom, x represent 0 or 1 and R″ represents a linear or branched alkyl group containing from 1 to 12 carbon atoms, or —O—(C═O)—R″ wherein R″ as the same meanings disclosed above.

Preferably, the aliphatic ethylenically unsaturated monomer having general formula (I) may be selected from: ethylene, propylene, 1-butene, isobutylene, 1-pentene, 4-methyl-1-pentene, 1-hexene, 1-octene, 1-dodecene, ethyl-10-undecenoate, vinyl acetate, butyl acrylate, or mixtures thereof. Ethylene, propylene, 1-hexene, 1-octene, ethyl-10-undecenoate, vinyl acetate, butyl acrylate, or mixtures thereof, are particularly preferred.

With regard to the aromatic ethylenically unsaturated monomer, the term “aromatic ethylenically unsaturated monomer” generally means an ethylenically unsaturated monomer having general formula (II):

CH₂═CH—(R₁R₂C)ₓ—(C₆H_{5-z})_{y}(R₃)_{z} (II)

wherein R₁, R₂ and R₃, which may be equal or different from each other, represents a hydrogen atom or a linear or branched alkyl group containing from 1 to 8 carbon atoms; or R₃, different from R₁ and R₂, represents an alkoxy group, a carboxyl group, an acyloxy group, said acyloxy group optionally being substituted with alkyl groups containing from 1 to 8 carbon atoms or hydroxyl groups or halogen atoms; x and z are 0 or an integer of from 1 to 5, extremes included; and y is 1 or 2.

Preferably, the aromatic ethylenically unsaturated monomer having general formula (II) may be selected from: styrene; mono- or polyalkylstyrenes such as, for example, 4-methylstyrene, dimethylstyrene, ethylstyrene, vinyltoluene; styrene derivatives containing functional groups such as, for example, methoxystyrene, ethoxystyrene, vinylbenzoic acid, methyl vinylbenzoate, vinylbenzyl acetate, hydroxystyrene, chlorostyrene, divinylbenzene; phenyl-substituted alkenes such as, for example, allylbenzene, 4-phenylbutene-1,3-phenyl-butene-1,4-(4-methylphenyl)butene-1,4-(3-methylphenyl)butene-1,4-(2-methylphenyl)butene-1,4-(4-ethylphenyl)butene-1,4-(4-butylphenyl)butene-1,5-phenylpentene-1,4-phenylpentene-1,3-phenylpentene-1, 5 (4-methylphenyl)pentene-1,4-(2-methylphenyl)-pentene-1,3-(4-methylphenyl)pentene-1,6-phenyl-hexene-1,5-phenylhexene-1,4-phenylhexene-1,3-phenyl-hexene-1,6-(4-methylphenyl)hexene-1,5-(2-methylphenyl)hexene-1,4-(4-methylphenyl)hexene-1,3-(2-methylphenyl)hexene-1,7-phenylheptene-1,6-phenylheptene-1,5-phenylheptene-1,4-phenylheptene-1,8-phenyloctene-1,7-phenyloctene-1,6-phenyloctene-1,5-phenyloctene-1,4-phenyloctene-1,3-phenyloctene-1,10-phenyldecene-1; or mixtures thereof. Styrene is particularly preferred.

As disclosed above, the polymerizing step according to the present invention may be carried out in the presence of carbon monoxide. Preferably, said carbon monoxide may be used in stoichiometric amount with respect to the ethylenically unsaturated monomer.

As disclosed above, the polymerizing step according to the present invention may be carried out in the presence of water. Preferably, the amount of water exceed the amount of the vulcanized rubber in a subdivided form, more preferably the water may be used in an amount of from 10 times to 200 times, more preferably of from 50 times to 100 times, with respect to the total weight of the vulcanized rubber in a subdivided form.

As disclosed above, the polymerizing step according to the present invention may be carried out in the presence of at least one inert solvent. Said inert solvent may be selected, for example, from: aromatic hydrocarbons (for example, benzene, toluene, ethylbenzene, xylene), alicyclic hydrocarbon (for example, cyclohexane), aliphatic hydrocarbons (for example, hexane, octane), ketones (for example, methyl ethyl ketone), esters (for example, ethyl acetate), ethers (for example, 1,4-dioxane), or mixtures thereof. Toluene is particularly preferred.

Preferably, the amount of solvent exceed the amount of the vulcanized rubber in a subdivided form, more preferably the solvent may be used in an amount of from 10 times to 200 times with respect to the total weight of the vulcanized rubber in a subdivided form.

Said process may be carried out continuously or batchwise, in one or more stages.

According to one preferred embodiment, the ethylenically unsaturated monomer may be used in an amount of from 1% by weight to 1000% by weight, preferably of from 20% by weight to 400% by weight, with respect to the total weight of the vulcanized rubber in a subdivided form and the olefin monomer.

At the end of the process, the obtained thermoplastic elastomeric material may be recovered in accordance with any methods known in the art such as, for example, by removing the unreacted monomer and the diluent solvent optionally present, by solvent extraction, or by heating under reduced pressure, or by extrusion by means of an extruder designed so as to remove volatile matter. The catalyst is deactivated and removed by washing with a solvent (for example, with a methanol solution containing 5% by volume of chloridric acid). Subsequently, the so obtained thermoplastic elastomeric material may be pelletized or powdered as needed.

Alternatively, the obtained thermoplastic elastomeric material may be recovered by a method such as separation by filtration or centrifugation, washed with water or with inert solvents, dried and subsequently pelletized or powdered as needed.

The pellets or powders may be either packaged for future use or used immediately in a process of forming a manufactured product.

As already above disclosed, the pellets or powders may be directly formed into manufactured products according to techniques known in the art for thermal processing of thermoplastic resin compositions. For example, compression molding, vacuum molding, injection molding, calendering, casting, extrusion, filament winding, laminating, rotational or slush molding, transfer molding, lay-up or contact molding, stamping, or combinations of these methods, may be used.

Alternatively, as already above disclosed, the obtained pellets or powder may be added as interface compatibilizing agent to other polymers, preferably to polymers having the same kind of polymeric chains. For example, the obtained thermoplastic elastomeric material in pellets or powder form, may be mixed or melt-mixed with polyolefins such as, for example, polyethylene, polypropylene, polystyrene, or with polyketones, to be used as a polymer blend; or may be mixed or melt-mixed with a polymer other than those above disclosed, said polymer being selected, for example, from: styrene-butadiene rubbers, polyphenylene ether resins, polycarbonates, polyesters, polyamides, to be used as a polymer blend.

Therefore, according to a further aspect, the present invention also relates to the use of a thermoplastic elastomeric material obtained by means of the process according to the present invention in blends with other polymers.

To the obtained thermoplastic elastomeric material conventional additives such as stabilizers [for example, antioxidants (phenolic antioxidants, phosphoric antioxidants), ultraviolet ray absorber (thermostabilizers)], flame-retardants, lubricants (for example, zinc stearate, calcium stearate, ethylene-bis-stearylamide), mold lubricants or parting agents, antistatic agents, fillers, colorants (for example, titanium oxide, red iron oxide, azo compounds, perylene, phthalocyanine, heterocyclic-series compounds), plasticizers and spreading agents (for example, polyethylene glycol, mineral oil), surface-modifying agents, or mixtures thereof, may be added.

According to a further aspect, the present invention also relates to a manufactured product comprising the thermoplastic elastomeric material above disclosed.

Said thermoplastic elastomeric material may be molded in sheet form and structural form designed and adaptable as packaging structures, housings, support structures, furnitures, molded articles, toys, architectural trims, and the like.

Moreover, said thermoplastic elastomeric material may also be used in order to make, for example, belts such as, for example, conveyor belts, power belts or driving belts; flooring and footpaths which may be used for recreational area, for industrial area, for sport or safety surfaces; flooring tiles; mats such as, for example, anti-static computer mats, automotive floor mats; mounting pads; shock absorbers sheetings; sound barriers; membrane protections; carpet underlay; automotive bumpers; wheel arch liner; seals such as, for example, automotive door or window seals; o-rings; gaskets; watering systems; pipes or hoses materials; flower pots; building blocks; roofing materials; and the like.

The present invention will be further illustrated below by means of a number of preparation examples, which are given for purely indicative purposes and without any limitation of this invention.

### EXAMPLE 1

### Preparation of the Thermoplastic Elastomeric Material by Ethylene Polymerization (Metallocene Catalyst)

A vulcanized rubber (cryogenically ground waste rubber from scrap tires (having an average diameter<0.1 mm (140 mesh)—Applied Cryogenics International AG) was extracted with boiling toluene in order to remove plasticizers, accelerators, crosslinking agents, and other additives usually present in the vulcanized rubber obtained from scrap tires and was subsequently dried under vacuum until constant weight.

In a 50 ml glass tube, 0.5 g of the vulcanized rubber obtained as disclosed above, were swollen in 10 ml of toluene overnight, at room temperature. Afterward, 10 ml (15 mmol) of methylalumoxane (MAO) were added and the mixture was stirred, at 60° C., for 1 hour.

Afterward, 1 ml (1.5 μmol) of a 1.5×10⁻³ M solution of bis(cyclopentadienyl)zirconium dichloride in toluene was added and the mixture was stirred, at 80° C., for 2.5 hours.

The surface-treated vulcanized rubber obtained as disclosed above was added to a 200 ml glass reactor vessel (Büchi) containing 80 ml of freshly distilled toluene equipped with a mechanical stirrer under argon pressure. The ethylene (purity>99.9% from Rivoira) was then added and the mixture was stirred and maintained under constant pressure of 2 bar, for 1 hour. The mixture was then quenched with 10 ml of an HCl/methanol solution (5% in volume).

The obtained thermoplastic elastomeric material was filtered, washed with methanol and subsequently dried under vacuum until constant weight. The so obtained thermoplastic elastomeric material showed the following composition: 91% by weight of polyethylene, 9% by weight of vulcanized rubber in a subdivided form.

### EXAMPLE 2

### Preparation of the Thermoplastic Elastomeric Material by Ethylene Polymerization (Metallocene Catalyst)

A vulcanized rubber (cryogenically ground waste rubber from scrap tires (having an average diameter<0.1 mm (140 mesh)—Applied Cryogenics International AG) was extracted with boiling toluene in order to remove plasticizers, accelerators, crosslinking agents, and other additives usually present in the vulcanized rubber obtained from scrap tires and was subsequently dried under vacuum until constant weight.

In a 50 ml glass tube flask, 1.5 g of the vulcanized rubber obtained as disclosed above, were swollen in 10 ml of toluene overnight, at room temperature. Afterward, 10 ml (15 mmol) of methylalumoxane (MAO) were added and the mixture was stirred, at 60° C., for 1 hour.

Afterward, 1 ml (1.5 μmol) of a 0.5×10 M solution of bis(cyclopentadienyl)zirconium dichloride in toluene was added and the mixture was stirred, at 80° C., for 2.5 hours.

The surface-treated vulcanized rubber obtained as disclosed above was added to a 200 ml glass reactor vessel (Büchi) containing 80 ml of freshly distilled toluene equipped with a mechanical stirrer under argon pressure. The ethylene monomer (purity>99.9% from Rivoira) was then added and the mixture was stirred and maintained under constant pressure of 2 bar, for 1 hour. The mixture was then quenched with 10 ml of an HCl/methanol solution (5% in volume).

The obtained thermoplastic elastomeric material was filtered, washed with methanol and subsequently dried under vacuum until constant weight. The so obtained thermoplastic elastomeric material showed the following composition: 65% by weight of polyethylene and 35% by weight of vulcanized rubber in a subdivided form.

### EXAMPLE 3

### Preparation of the Thermoplastic Elastomeric Material by Ethylene Polymerization (Metallocene Catalyst)

A vulcanized rubber (cryogenically ground waste rubber from scrap tires (having an average diameter<0.1 mm (140 mesh)—Applied Cryogenics International AG) was extracted with boiling toluene in order to remove plasticizers, accelerators, crosslinking agents, and other additives usually present in the vulcanized rubber obtained from scrap tires and was subsequently dried under vacuum until constant weight.

In a 50 ml glass tube flask, 0.5 g of the vulcanized rubber obtained as disclosed above, were swollen in 10 ml of toluene overnight, at room temperature. Afterward, 10 ml (15 mmol) of methylalumoxane (MAO) were added and the mixture was stirred, at 60° C., for 1 hour.

Afterward, 0.33 ml (0.5 μmol) of a 1.5×10⁻³ M solution of bis(cyclopentadienyl)zirconium dichloride in toluene was added and the mixture was stirred, at 80° C., for 2.5 hours.

The surface-treated vulcanized rubber obtained as disclosed above was added to a 200 ml glass reactor vessel (Büchi) containing 80 ml of freshly distilled toluene equipped with a mechanical stirrer under argon pressure. The ethylene monomer (purity>99.9% from Rivoira) was then added and the mixture was stirred and maintained under constant pressure of 2 bar, for 1 hour. The mixture was then quenched with 10 ml of an HCl/methanol solution (5% in volume).

The obtained thermoplastic elastomeric material was filtered, washed with methanol and subsequently dried under vacuum until constant weight. The so obtained thermoplastic elastomeric material showed the following composition: 57% by weight of polyethylene and 43% by weight of vulcanized rubber in a subdivided form.

### EXAMPLE 4

### Preparation of the Thermoplastic Elastomeric Material by ethylene/ethyl-10-undecenoate Copolymerization (Metallocene Catalyst)

A vulcanized rubber (cryogenically ground waste rubber from scrap tires (having an average diameter<0.1 mm (140 mesh)—Applied Cryogenics International AG) was extracted with boiling toluene in order to remove plasticizers, accelerators, crosslinking agents, and other additives usually present in the vulcanized rubber obtained from scrap tires and was subsequently dried under vacuum until constant weight.

In a 50 ml glass tube flask, 0.5 g of the vulcanized rubber obtained as disclosed above, were swollen in 10 ml of toluene overnight, at room temperature. Afterward, 10 ml (15 mmol) of methylalumoxane (MAO) were added and the mixture was stirred, at 60° C., for 1 hour.

Afterward, 1 ml (1.5 μmol) of a 1.5×10⁻³ M solution of bis(cyclopentadienyl)zirconium dichloride in toluene was added and the mixture was stirred, at 80° C., for 2.5 hours.

The surface-treated vulcanized rubber obtained as disclosed above was added to a 200 ml glass reactor vessel (Büchi) containing 80 ml of freshly distilled toluene equipped with a mechanical stirrer under argon pressure.

The ethylene (purity>99.9% from Rivoira) was then added and the mixture was stirred and maintained under constant pressure of 2 bar, for 5 minutes. Then, the ethylene flux was interrupted, the mixture was brought to atmospheric pressure and a solution of 0.41 ml (1.679 mmol) of ethyl-10-undecenoate and 5 ml (7.5 mmol) of methylalumoxane MAO in toluene, which were previously pre-complexed for 15 minutes, was introduced. Afterward, the ethylene (purity>99.9% from Rivoira) was added and the mixture was stirred and maintained under constant pressure of 2 bar, for 1 hour. The mixture was then quenched with 10 ml of an HCl/methanol solution (5% in volume).

The obtained thermoplastic elastomeric material was filtered, washed with methanol and subsequently dried under vacuum until constant weight. The so obtained thermoplastic elastomeric material showed the following composition: 58% by weight of ethylene-co-ethylundecenoate copolymer and 42% by weight of vulcanized rubber in a subdivided form.

### EXAMPLE 5

### Preparation of the Thermoplastic Elastomeric Material by Ethylene Polymerization (Ziegler Natta Catalyst)

A vulcanized rubber (cryogenically ground waste rubber from scrap tires (having an average diameter<0.1 mm (140 mesh)—Applied Cryogenics International AG) was extracted with boiling toluene in order to remove plasticizers, accelerators, crosslinking agents, and other additives usually present in the vulcanized rubber obtained from scrap tires and was subsequently dried under vacuum until constant weight.

In a 50 ml glass tube flask, 0.5 g of the vulcanized rubber obtained as disclosed above, were swollen in 10 ml of toluene overnight, at room temperature. Afterward, 10 ml (20 mmol) of Al(Et)₃ were added and the mixture was stirred, at 60° C., for 1 hour.

Afterward, 0.2 ml (200 μmol) of TiCl₄ was added and the mixture was stirred, at 80° C., for 2.5 hours.

The surface-treated vulcanized rubber obtained as disclosed above was added to a 200 ml glass reactor vessel (Büchi) containing 80 ml of freshly distilled toluene equipped with a mechanical stirrer under argon pressure. The ethylene (purity>99.9% from Rivoira) was then added and the mixture was stirred and maintained under constant pressure of 2 bar, for 1 hour. The mixture was then quenched with 10 ml of an HCl/methanol solution (5% in volume)

The obtained thermoplastic elastomeric material was filtered, washed with methanol and subsequently dried under vacuum until constant weight. The so obtained thermoplastic elastomeric material showed the following composition: 46% by weight of polyethylene and 54% by weight of vulcanized rubber in a subdivided form.

### EXAMPLE 6

### Preparation of the Thermoplastic Elastomeric Material by Styrene Polymerization (Metallocene Catalyst)

A vulcanized rubber (cryogenically ground waste rubber from scrap tires (having an average diameter<0.1 mm (140 mesh)—Applied Cryogenics International AG) was extracted with boiling toluene in order to remove plasticizers, accelerators, crosslinking agents, and other additives usually present in the vulcanized rubber obtained from scrap tires and was subsequently dried under vacuum until constant weight.

In a 50 ml glass tube flask, 0.1 g of the vulcanized rubber obtained as disclosed above, were swollen in 25 ml of toluene overnight, at room temperature. Afterward, 10 ml (15 mmol) of methylalumoxane (MAO) were added and the mixture was stirred, at 50° C., for 1 hour.

Afterward, 0.81 ml (0.125 μmol) of a 15.4×10⁻³ M solution of pentamethylcyclopentadienyl titanium trichlopride in toluene and 5 ml (0.48 mol) of styrene the mixture were added and the mixture was stirred, at 50° C., for 2 hours. The mixture was then quenched with 10 ml of an HCl/methanol solution (5% in volume)

The obtained thermoplastic elastomeric material was filtered, washed with methanol and subsequently dried under vacuum until constant weight. The so obtained thermoplastic elastomeric material showed the following composition: by 52% by weight of sindiotactic polystyrene and 48% by weight of vulcanized rubber in a subdivided form.

### EXAMPLE 7

### Preparation of the Thermoplastic Elastomeric Material by Styrene Polymerization (Metallocene Catalyst)

A vulcanized rubber (cryogenically ground waste rubber from scrap tires (having an average diameter<0.1 mm (140 mesh)—Applied Cryogenics International AG) was extracted with boiling toluene in order to remove plasticizers, accelerators, crosslinking agents, and other additives usually present in the vulcanized rubber obtained from scrap tires, and was subsequently dried under vacuum until constant weight.

In a 50 ml glass tube flask, 0.1 g of the vulcanized rubber obtained as disclosed above, were swollen in 25 ml of toluene overnight, at room temperature. Afterward, 10 ml (15 mmol) of methylalumoxane (MAO) were added and the mixture was stirred, at 50° C., for 1 hour.

Afterward, 0.81 ml (0.125 μmol) of 15.4×10⁻³ M solution of pentamethylcyclopentadienyl titanium trimethoxide in toluene and 5 ml (0.48 mol) of styrene were added and the mixture was stirred, at 80° C., for 2 hours. The mixture was then quenched with 10 ml of an HCl/methanol solution (5% in volume).

The obtained thermoplastic elastomeric material was filtered, washed with methanol and subsequently dried under vacuum until constant weight. The so obtained thermoplastic elastomeric material showed the following composition: by 92% by weight of sindiotactic polystyrene and 8% by weight of vulcanized rubber in a subdivided form.

### EXAMPLE 8

### Preparation of the Thermoplastic Elastomeric Material Ethylene/Carbon Monoxide Copolymerization (Palladium Catalyst)

A vulcanized rubber (cryogenically ground waste rubber from scrap tires (having an average diameter<0.1 mm (140 mesh)—Applied Cryogenics International AG) was extracted with boiling acetone in order to remove plasticizers, accelerators, crosslinking agents, and other additives usually present in the vulcanized rubber obtained from scrap tires and was subsequently dried under vacuum until constant weight.

In a 250 ml glass tube flask, 1 g of the vulcanized rubber obtained as disclosed above, were swollen in 100 ml of methanol overnight, at room temperature. After removing oxygen, 4.64×10⁻⁵ moles of [(dppp)Pd(OTs) (H₂O)]OTs (dppp=1,3-bis(diphenylphosphinopropane; Ts=tosylate), 6.271×10⁻⁴ moles of p-toluene sulphonic acid, and 1.7666×10⁻³ moles of 1-4 benzoquinone, were added and the mixture was stirred, at room temperature, for 1 hour.

Afterward, the mixture was introduced in a stainless steel autoclave and a pressure of 20 bar of ethylene and 20 bar of CO was applied. The reaction was carried out at 85° C., with stirring at 1200 rpm, for 1.5 hours. Then, the reaction was interrupted and suddenly cooled to room temperature, after the releasing of the absorbed gases.

The obtained thermoplastic elastomeric material was filtered, washed with methanol and subsequently dried under vacuum until constant weight. The so obtained thermoplastic elastomeric material showed the following composition: by 88% by weight of polyketone and 12% by weight of vulcanized rubber in a subdivided form.

### EXAMPLE 9

### Preparation of the Thermoplastic Elastomeric Material Ethylene/Carbon Monoxide Copolymerization (Palladium Catalyst)

A vulcanized rubber (cryogenically ground waste rubber from scrap tires (having an average diameter<0.1 mm (140 mesh)—Applied Cryogenics International AG) was extracted with boiling acetone in order to remove plasticizers, accelerators, crosslinking agents, and other additives usually present in the vulcanized rubber obtained from scrap tires and was subsequently dried under vacuum until constant weight.

In a 250 ml glass tube flask, 1 g of the vulcanized rubber obtained as disclosed above, were swollen in 100 ml of toluene overnight, at room temperature. After removing oxygen, 3.031×10⁻⁵ moles of [(dppp)Pd(CH₃)(NCCH₃)]B[(C₆H₃)(CF₃)₂]₃ (dppp=1,3-bis(diphenylphosphinopropane), 2.4802×10⁻³ moles of 1-4 benzoquinone, were added and the mixture was stirred, at room temperature, for 1 hour.

Afterward, the mixture was introduced in a stainless steel autoclave and a pressure of 20 bar of ethylene and 20 bar of CO was applied. The reaction was carried out at 85° C., with stirring at 1200 rpm, for 2.5 hours. Then, the reaction was interrupted and suddenly cooled to room temperature, after the releasing of the absorbed gases.

The obtained thermoplastic elastomeric material was filtered, washed with methanol and subsequently dried under vacuum until constant weight. The so obtained thermoplastic elastomeric material showed the following composition: by 70% by weight of polyketone and 30% by weight of vulcanized rubber in a subdivided form.

### EXAMPLE 10

The thermoplastic elastomeric materials obtained in Examples 1 and 2, were subjected to measurement of the mechanical properties as follows.

To this aim, films of about 200 micron thick were obtained from the thermoplastic materials obtained as disclosed above. The films were prepared by moulding for 10 minutes at 180° C. and subsequent cooling for 5 minutes to room temperature.

Dumbell samples where obtained from the films above disclosed and were used to measure the following mechanical properties tensile strength at yield, elongation at yield, stress at break, elongation at break and tangent modulus, according to ASTM standard D638-02a, using a dinamometer instrument (Tinius-Olsen), at a traction speed of 10 mm/min. The obtained results are given in Table 1.

For comparative purposes, films obtained from a polyethylene produced by means of the same process disclosed in Example 1, the only difference being the absence of the vulcanized rubber in a subdivided form, was made (PE ref.).

Moreover, for comparative purposes, a film obtained by mechanically blending 91% by weight of a polyethylene obtained as disclosed above and 9% by weight of a vulcanized rubber in a subdivided form obtained as disclosed in Example 1, was made (BLEND ref.).

TABLE 1

| | TENSILE | | STRESS | | |
|---|---|---|---|---|---|
| | STRENGTH | | AT | | TANGENT |
| | AT YIELD | ELONGATION | BREAK | ELONGATION | MODULUS |
| EXAMPLE | (MPa) | AT YIELD (%) | (MPa) | AT BREAK (%) | (MPa) |
| PE ref. (*) | 23.8 | 16.6 | 37.0 | 1704.3 | 343 |
| BLEND ref. (*) | 25.3 | 14.0 | 25.7 | 17.3 | 467 |
| EXAMPLE 1 | 20.2 | 18.8 | 25.4 | 991.0 | 304 |
| EXAMPLE 2 | 21.0 | 20.7 | 21.7 | 871.3 | 297 |

(*) comparative.

1-53. (canceled)

54. A process for manufacturing a thermoplastic elastomeric material comprising at least one elastomeric phase and at least one thermoplastic phase, comprising the following steps:
surface-treating a vulcanized rubber in a subdivided form with an effective amount of at least one organometallic polymerization catalyst; and
polymerizing at least one ethylenically unsaturated monomer in the presence of said surface-treated vulcanized rubber in a subdivided form to obtain at least one thermoplastic phase.

55. The process according to claim 54, wherein said organometallic polymerization catalyst is selected from Ziegler-Natta catalysts and metallocene catalysts.

56. The process according to claim 54, carried out in the presence of carbon monoxide.

57. The process according to claim 54, wherein said thermoplastic elastomeric material is a copolymer of at least one ethylenically unsaturated monomer and carbon monoxide and said organometallic polymerization catalyst is selected from polymerization catalysts containing ligands, comprising:
(a) a metal compound, said metal belonging to group VIIIA of the Periodic Table of the Elements;
(b) an anion of an acid with a pKa of less than 2 or a metal salt thereof; and
(c) a bidentate ligand.

58. The process according to claim 54, wherein said organometallic polymerization catalyst is used in an amount of 0.01% by weight to 5% by weight with respect to the total weight of the vulcanized rubber in a subdivided form.

59. The process according to claim 58, wherein said organometallic polymerization catalyst is used in an amount of 0.05% by weight to 1% by weight with respect to the total weight of the vulcanized rubber in a subdivided form.

60. The process according to claim 54, wherein said polymerizing step is carried out at a temperature of 20° C. to 100° C.

61. The process according to claim 60, wherein said polymerizing step is carried out at a temperature of 30° C. to 90° C.

62. The process according to claim 54, wherein said polymerizing step is carried out at a pressure of 1 bar to 60 bar.

63. The process according to claim 62, wherein said polymerizing step is carried out at a pressure of 2 bar to 45 bar.

64. The process according to claim 54, wherein said polymerizing step is carried out for 5 minutes to 10 hours.

65. The process according to claim 64, wherein said polymerizing step is carried out for 10 minutes to 3 hours.

66. The process according to claim 54, wherein said vulcanized rubber in a subdivided form is in the form of powder or granules having a particle size not higher than 10 mm.

67. The process according to claim 54, wherein said vulcanized rubber in a subdivided form is in the form of powder or granules having a particle size not higher than 0.5 mm.

68. The process according to claim 67, wherein said vulcanized rubber in a subdivided form is in the form of powder or granules having a particle size not higher than 0.2 mm.

69. The process according to claim 67, wherein said vulcanized rubber in a subdivided form is in the form of powder or granules having a particle size not higher than 0.1 mm.

70. The process according to claim 54, wherein said vulcanized rubber in a subdivided form comprises at least one crosslinked diene elastomeric polymer or copolymer which is of natural origin or is obtained by solution polymerization, emulsion polymerization or gas-phase polymerization of one or more conjugated diolefins, or one or more conjugated diolefins blended with at least one comonomer selected from monovinylarenes and/or polar comonomers in an amount of not more than 60% by weight.

71. The process according to claim 70, wherein said crosslinked diene elastomeric polymer or copolymer is selected from: cis-1,4-polyisoprene, 3,4-polyisoprene, polybutadiene, halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

72. The process according to claim 54, wherein said vulcanized rubber in a subdivided form further comprises at least one crosslinked elastomeric polymer of one or more monoolefins with an olefinic comonomer or derivatives thereof.

73. The process according to claim 72, wherein said crosslinked elastomeric polymer is selected from: ethylene/propylene copolymers or ethylene/propylene/diene copolymers; polyisobutene; butyl rubbers; halobutyl rubbers, chlorobutyl rubbers; bromobutyl rubbers; or mixtures thereof.

74. The process according to claim 55, wherein said Ziegler-Natta catalysts are selected from those obtained by mixing an organometallic compound of a metal belonging to Group IA, IIA, or IIIB of the Periodic Table of the Elements with a compound of a transition metal belonging to Group IVA, VA, VIA, or VIIIA of the Periodic Table of the Elements.

75. The process according to claim 74, wherein said organometallic compounds of a metal belonging to Group IA, IIA, or IIIB of the Periodic Table of the Elements comprise the hydrides, aluminum alkyls, aluminum haloalkyl, alkylaluminum halides, Grignard reagents, alkali metal aluminium hydrides, alkali metal borohydrides, alkali metal hydrides, alkaline earth metal hydrides, or mixtures thereof.

76. The process according to claim 74, wherein said compound of a transition metal belonging to Group IVA, VA, VIA, or VIIIA of the Periodic Table of the Elements is selected from: halogenides, chlorides, bromides, or fluorides; oxides or hydroxides; or organic compounds, alcoholates, acetates, benzoates, acetyl acetonates; or mixtures thereof.

77. The process according to claim 74, wherein said Ziegler-Natta catalysts are obtained by mixing aluminum trimethyl or aluminum triethyl with titanium tetrachloride.

78. The process according to claim 55, wherein said metallocene catalysts are selected from compounds having the following general formulae (III) or (IV):
(C₅R′ₘ)ₚR″ₛ(C₅R′ₘ)M(Q)₃₋ₚ (III)
R″ₛ(C₅R′ₘ)M(Q′) (IV)
wherein:
C₅R′ₘ represents an unsubstituted or substituted and/or fused cyclopentadienyl group;
R′ groups, which may be the same or different from each other, represent a hydrocarbyl group, alkyl, alkenyl, aryl, alkylaryl, or arylalkyl groups containing 1 to 20 carbon atoms, or two adjacent carbon atoms which are joined together to form a C₄-C₆ ring;
R″ represents a C₁-C₄ alkylene group, a dialkyl germanium or silicone, or an alkyl phosphine or amine group bridging two C₅R′ₘ rings;
M represents a transition metal belonging to groups IVA, VA, VIA, or VIIIA of the Periodic Table of Elements;
Q groups, which may be the same or different from each other, represent a hydrocarbyl group, an alkyl group, an alkoxy group, an alkenyl group, an aryl group, an alkylaryl group, or arylalkyl groups, containing 1 to 20 carbon atoms, or halogen atoms;
Q′ represents an alkylidene group having 1 to 20 carbon atoms;
p is 0, 1, or 2;
s is 0 or 1; and
n and z are 0, or an integer of from 1 to 3, extremes included.

79. The process according to claim 78, wherein said compounds having general formulae (III) or (IV) are selected from: cyclopentadienyl titanium or zirconium trichloride, pentamethylcyclopentadienyl titanium or zirconium trichloride, pentamethylcyclopentadienyl titanium or zirconium trimethoxide, bis(cyclopentadienyl) titanium or zirconium diphenyl, bis-(cyclopentadienyl)titanium or zirconium dimethyl, bis (cyclopentadienyl)titanium or zirconium methyl chloride, bis(cyclopentadienyl)titanium or zirconium ethylchloride, bis(cyclopentadienyl)titanium or zirconium dichloride, bis(n-butylcyclopentadienyl)titanium or zirconium dichloride, bis(n-dodecylcyclopentadienyl)titanium or zirconium dichloride, ethylene-bis(tetrahydroindenyl) titanium or zirconium dichloride, ethylene bis(tetrahydroindenyl)titanium or zirconium dimethyl, ethylene-bis-(indenyl)titanium or zirconium dichloride, ethylene-bis(indenyl)titanium or zirconium dimethyl, dimethylsilanylene-bis-(tetrahydroindenyl)-titanium or zirconium dichloride, dimethyl-silanylene-bis(tetrahydroindenyl) titanium or zirconium dimethyl, dimethyl, silanylene-bis(indenyl) titanium or zirconium dichloride, dimethylsilanylene-bis(indenyl) titanium or zirconium dimethyl.

80. The process according to claim 79, wherein said compounds having general formulae (III) or (IV) are selected from: pentamethyl cyclopentadienyl titanium trichloride, pentamethylcyclopentadienyl titanium trimethoxide, or bis (cyclopentadienyl) zirconium dichloride.

81. The process according to claim 78, wherein said compound having general formulae (III) or (IV) is used in combination with a co-catalyst represented by the following general formulae (V) or (VI):
(R—Al—O)ₙ (V)
which is a cyclic compound,
R(R—Al—O)ₙAlR₂ (VI)
which is a linear compound,
wherein:
R groups, which may be the same or different from each other, represent a linear or branched C₁-C₅ alkyl group, methyl group, ethyl group, propyl group, butyl group, or pentyl group; and
n is an integer of from 1 to 20, extremes included.

82. The process according to claim 81, wherein said co-catalyst is methylalumoxane.

83. The process according to claim 78, wherein said compounds having general formulae (III) or (IV) are used in combination with a co-catalyst selected from organoboron compounds, trifluoroborane, tris(4-fluorophenyl)borane, tris(3,5-difluorophenyl) borane, tris(4-fluoromethylphenyl)-borane, tris(3,4,5-trifluorophenyl)borane, tris(penta-fluorophenyl)borane, tris(tolyl)borane, tris(3,5-dimethyl-phenyl) borane, or mixtures thereof.

84. The process according to claim 57, wherein said organometallic polymerization catalyst containing ligands comprises:
(a) a metal compound, a palladium compound, a cobalt compound, an iron compound, or a nickel compound;
(b) an anion of an acid with a pKa of less than 2 or a metal salt thereof; and
(c) a bidentate ligand having the following general formula (VII):
R¹R²-M¹-R³-M¹-R⁴R⁵ (VII)
wherein:
R¹, R², R³, R⁴ and R⁵, which may be the same or different from each other, represent a hydrocarbon group containing from 2 to 18 carbon atoms;
M¹ represents phosphorous, arsenicum or antimony; and
R³ represents a bivalent organic bridging group having at least two carbon atoms in the bridge, a —(CR⁶R⁷)ₙ— group wherein R⁶ and R⁷ represent a hydrogen atom or a hydrocarbon group offering no steric hindrance, and n is an integer of from 2 to 4, extremes included; an aryl group, a phenyl group, a benzene group, a naphthalene group; a cycloaliphatic group, or a cyclohexane group.

85. The process according to claim 84, wherein said metal compound (a) is selected from palladium salts of a carboxylic acid, palladium acetate, palladium trifluoroacetate, palladium tosilate; or from palladium salts, [PdCl(Me)(cod)], wherein (cod=cycloocta-1,5-diene), or mixtures thereof.

86. The process according to claim 84, wherein said anion of an acid with a pKa of less than 2 or a metal salt thereof (b) is selected from anions derived from the following acids or metal salts thereof:
mineral protonic acids which are selected from: sulphuric acid, nitric acid, boric acid, tetrafluoroboric acid, perchloric acid, sulphonic acid, methane sulphonic acid, trifluoromethanesulphonic acid, p-toluene sulphonic acid, trichloroacetic acid, trifluoroacetic acid, or mixtures thereof;
Lewis acids which are selected from: boron compounds, triphenylborane, tris(penta-fluorophenyl) borane, (p-chlorophenyl) borane, tris[3,5-bis (trifluoromethyl)phenyl]borane; or from compounds of aluminum, of zinc, of antimony, or of titanium which have Lewis-acid character; or mixtures thereof; or mixtures thereof.

87. The process according to claim 84, wherein said bidentate ligand (c) is selected from: 1,3-di(diphenylphosphine) propane, 1,4-di(diphenyl-phosphine) butane, 2,3-dimethyl-1,4-di(diphenyl-phosphine) butane, 1,4-di-(dicyclohexylphosphine) butane, 1,5-di(dinaphthylphosphine)pentane, 1,2-di-(diphenyl-phosphine)benzene, 1,2-di(diphenylphosphine)-cyclohexane, or mixtures thereof.

88. The process according to claim 84, wherein said metal catalysts containing ligands further comprise at least one compound (d) selected from 1,4-quinones, 1,4-benzoquinone, 1,4-naphthoquinone, or mixtures thereof.

89. The process according to claim 54, wherein said vulcanized rubber in a subdivided form is subjected, before being subjected to a surface treating step, to a solvent extraction.

90. The process according to claim 54, wherein, in the case of Ziegler-Natta catalysts, said surface treating step comprises the following steps:
(i) reacting said vulcanized rubber in a subdivided form, previously swollen in an inert solvent, toluene, methanol, or mixtures thereof, with at least one organometallic compound of a metal belonging to Group IA, IIA, or IIIB of the Periodic Table of the Elements, at a temperature of 30° C. to 80° C., for 30 minutes to 2 hours, said organometallic compound being used in an amount of 10% by weight to 150% by weight with respect to the total weight of the vulcanized rubber in a subdivided form; and
(ii) reacting the compound obtained in step (i) with a compound of a transition metal belonging to Group IVA, VA, VIA, or VIIIA of the Periodic Table of the Elements, at a temperature of 40° C. to 100° C., for 30 minutes to 4 hours, said compound of a transition metal belonging to Group IVA, VA, VIA, or VIIIA of the Periodic Table of the Elements being used in an amount of 1% by weight to 10% by weight with respect to the total weight of the vulcanized rubber in a subdivided form.

91. The process according to claim 54, wherein, in the case of metallocene catalysts, said surface treating step comprises the following steps:
(i′) reacting said vulcanized rubber in a subdivided form, previously swollen in an inert solvent, toluene, methanol, or mixtures thereof, with at least one aluminoxane having general formulae (V) or (VI), in the presence of an inert solvent or toluene, at a temperature of 30° C. to 80° C., for 30 minutes to 2 hours, said aluminoxane being used in an amount of 10% by weight to 1500% by weight with respect to the total weight of the vulcanized rubber in a subdivided form; and
(ii′) reacting the compound obtained in step (i′) with at least one compound having general formulae (III) or (IV), at a temperature of 40° C. to 100° C., for 30 minutes to 4 hours, said compound having general formulae (III) or (IV) being used in an amount of 0.01% by weight to 5% by weight, or 0.05% by weight to 1% by weight, with respect to the total weight of the vulcanized rubber in a subdivided form.

92. The process according to claim 54, wherein, in the case of the organometallic catalysts containing a ligand, said surface treating comprises the reaction of said vulcanized rubber in a subdivided form, previously swollen in an inert solvent, toluene, methanol, or mixtures thereof, with at least one organometallic polymerization catalyst containing ligands comprising: (a) a metal compound, said metal belonging to group VIIIA of the Periodic Table of the Elements; (b) an anion of an acid with a pKa of less than 2 or a metal salt thereof; and (c) a bidentate ligand, at a temperature of 10° C. to 50° C., for 60 minutes to 2 hours, said catalyst being used in an amount of 0.01% by weight to 1% by weight with respect to the total weight of the vulcanized rubber in a subdivided form.

93. The process according to claim 54, wherein said at least one ethylenically unsaturated monomer is selected from aliphatic ethylenically unsaturated monomer having general formula (I):
CH₂═CH—R (I)
wherein R represents a hydrogen atom; a linear or branched alkyl group containing from 1 to 12 carbon atoms; —(R′)ₓ—COO—R″ wherein R′ represents a linear or branched alkylene group containing from 1 to 20 carbon atoms, x represents 0 or 1 and R″ represents a linear or branched alkyl group containing from 1 to 12 carbon atoms; or —O—(C═O)—R″ wherein R″ has the same meanings disclosed above.

94. The process according to claim 93, wherein said aliphatic ethylenically unsaturated monomer having general formula (I) is selected from: ethylene, propylene, 1-butene, isobutylene, 1-pentene, 4-methyl-1-pentene, 1-hexene, 1-octene, 1-dodecene, ethyl-10-undecenoate, vinyl acetate, butyl acrylate, or mixtures thereof.

95. The process according to claim 54, wherein said at least one ethylenically unsaturated monomer is selected from aromatic ethylenically unsaturated monomer having general formula (II):
CH₂═CH—(R₁R₂C)ₓ—(C₆H_{5-z})_{y}(R₃)_{z} (II)
wherein R₁, R₂ and R₃, which may be the same or different from each other, represent a hydrogen atom or a linear or branched alkyl group containing from 1 to 8 carbon atoms; or R₃, different from R₁ and R₂, represents an alkoxy group, a carboxyl group, an acyloxy group, said acyloxy group optionally being substituted with alkyl groups containing from 1 to 8 carbon atoms or hydroxyl groups or halogen atoms; x and z are 0 or an integer of from 1 to 5, extremes included; and y is 1 or 2.

96. The process according to claim 95, wherein said aromatic ethylenically unsaturated monomer having general formula (II) is selected from: styrene; mono- or polyalkylstyrenes, 4-methylstyrene, dimethylstyrene, ethylstyrene, vinyltoluene, styrene derivatives containing functional groups, methoxystyrene, ethoxystyrene, vinylbenzoic acid, methyl vinylbenzoate, vinylbenzyl acetate, hydroxystyrene, chlorostyrene, divinylbenzene; phenyl-substituted alkenes, allylbenzene, 4-phenylbutene-1,3-phenyl-butene-1,4-(4-methyl-phenyl) butene-1,4-(3-methylphenyl) butene-1,4-(2-methylphenyl) butene-1,4-(4-ethylphenyl) butene-1,4-(4-butylphenyl) butene-1,5-phenylpentene-1,4-phenylpentene-1,3-phenylpentene-1,5(4-methylphenyl) pentene-1,4-(2-methylphenyl)-pentene-1,3-(4-methylphenyl) pentene-1,6-phenyl-hexene-1,5-phenylhexene-1,4-phenylhexene-1,3-phenyl-hexene-1,6-(4-methylphenyl) hexene-1,5-(2-methylphenyl) hexene-1,4-(4-methylphenyl) hexene-1,3-(2-methylphenyl) hexene-1,7-phenylheptene-1,6-phenylheptene-1,5-phenylheptene-1,4-phenylheptene-1,8-phenyloctene-1,7-phenyloctene-1,6-phenyloctene-1,5-phenyloctene-1,4-phenyloctene-1,3-phenyloctene-1,10-phenyldecene-1; or mixtures thereof.

97. The process according to claim 56, wherein said carbon monoxide is used in stoichiometric amount with respect to the ethylenically unsaturated monomer.

98. The process according to claim 54, wherein said polymerizing step is carried out in the presence of water.

99. The process according to claim 54, wherein said polymerizing step is carried out in the presence of at least one inert solvent selected from: aromatic hydrocarbons, alicyclic hydrocarbon, aliphatic hydrocarbons, ketones, esters, ethers, or mixtures thereof.

100. The process according to claim 54, wherein said ethylenically unsaturated monomer is used in an amount of 1% by weight to 1000% by weight with respect to the total weight of the vulcanized rubber in a subdivided form and the olefin monomer.

101. The process according to claim 100, wherein said ethylenically unsaturated monomer is used in an amount of 20% by weight to 400% by weight with respect to the total weight of the vulcanized rubber in a subdivided form and the olefin monomer.

102. A thermoplastic elastomeric material obtained according to claim 54, comprising:
10% by weight to 99% by weight with respect to the total weight of the thermoplastic elastomeric material, of at least one thermoplastic polymer; and
1% by weight to 90% by weight with respect to the total weight of the thermoplastic elastomeric material, of a vulcanized rubber in a subdivided form.

103. The thermoplastic elastomeric material according to claim 102, comprising a blend with polyethylene, polypropylene, polystyrene, or polyketones.

104. The thermoplastic elastomeric material according to claim 102, comprising a blend with styrene-butadiene rubbers, polyphenylene ether resins, polycarbonates, polyesters, or polyamides.

105. A manufactured product obtained by molding a thermoplastic elastomeric material according to claim 102.

106. The manufactured product according to claim 105, wherein said manufactured product comprises packaging structures, housings, support structures, furniture, molded articles, toys, or architectural trims.

107. The manufactured product according to claim 106, wherein said manufactured product comprises belts; flooring and footpaths; flooring tiles; mats; shock absorber sheetings; sound barriers; membrane protectors; carpet underlay; automotive bumpers; wheel arch liner; seals; o-rings; gaskets for watering systems; pipe or hose materials; flower pots; building blocks; roofing materials; or geomembranes.
